(19) United States
(12) Patent Application Publication
(10) Pub. No.: US 2009/0006194 A1
(43) Pub. Date: Jan. 1, 2009

(54) Location, destination and other contextual information-based mobile advertisements

(75) Inventors: Prashant Sridharan, Seattle, WA (US); Thomas L. Button, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/823,142

(22) Filed: Jun. 27, 2007

(51) Int. Cl. G06Q 30/00

(52) U.S. Cl. 705/14; 701/207

(57) ABSTRACT

Described is a technology by which an advertisement is selected for output on a mobile (e.g., vehicle navigation) system based on contextual data, including current state data from a location-sensing (e.g., GPS) device. The advertisement may be an image displayed at a location on a map corresponding to a physical location of the advertiser. The contextual data may include location, direction and destination data, user preference data and user-provided data such as calendar, task and/or contacts data. Examples of other contextual data include age data, gender data, number of vehicle occupants data, vehicle make data, vehicle model data, and/or vehicle style data. In one aspect, the user may interact with the advertisement, e.g., to communicate an order for a product or service corresponding to the advertisement.

### BACKGROUND

Automotive navigation systems built into vehicles, and other mobile devices such as GPS-equipped handheld devices and phones, can provide mobile mapping services to users. For example, a user can view a map that regularly updates itself based on the user's current location, and can hear computer-generated directions and the like based upon a current location and a specified destination.

Mobile mapping also may include advertisements. However, while at times valuable for a mobile user to see an advertisement, too many advertisements can be distracting, and in fact can cause a mobile user to miss a desired one because of too many advertisements being visible while the user is in one area, and no relevant advertisements appearing while in another area.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an advertisement is selected for output on a mobile (e.g., vehicle navigation) system based on contextual data, including current state data from a location-sensing (e.g., GPS) device. The advertisement may be an image displayed at a location on a map (or proximate the location on the map) corresponding to a physical location of an advertiser The contextual data may include user preference data and user-provided data such as calendar, task and/or contacts data.

In one aspect, an advertisement selection mechanism is coupled to a source of contextual data including current state data, and coupled to access an advertisement data store to select a selected advertisement from the data store based on the contextual data. The selected advertisement is output to a mapping mechanism, e.g., of a vehicle navigation system. Examples of current state data include location data, speed data, time data, direction data, destination data, fuel level data, and/or route data. Examples of other contextual data include age data, gender data, number of vehicle occupants data, vehicle make data, vehicle model data, and/or vehicle style data.

In one aspect, the user may interact with the advertisement. For example, the interaction may cause communication to communicate an order for a product or service corresponding to the advertisement.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of targeted mobile advertisements may be incorporated.

FIGS. 2 and 3 are representations of example maps that may appear when a user is moving, including with an advertisement that is selected and output based on various state and contextual data.

FIG. 4 is a flow diagram showing an example of selectively updating a map and/or advertisement output based upon location or other state changes and various other contextual data.

### DETAILED DESCRIPTION

Various aspects of the technology described herein are generally directed towards delivering more relevant advertisements to end-users in automobiles, by combining location, destination and other contextual information to determine advertisement delivery. By way of example, a mobile consumer receives advertisements that are targeted for his or her needs based on specific contextual information that is known, such as gender, age, cuisine preferences for restaurants, make/model/style/status of automobile, and so forth, in association with specific knowledge about the user's present surroundings, such as precise location and direction, businesses within the area that match preference criteria, activity currently underway in the vehicle, and so forth.

While various examples are described herein to describe different types of contextual information that may be used to deliver an advertisement, it is understood that these are only examples, and that virtually any type of information known may be used to determine whether to deliver any advertisement, which advertisement to deliver, and/or how to deliver it. As such, the present invention is not limited to any particular embodiments, aspects, concepts, structures, functionalities or examples described herein. Rather, any of the embodiments, aspects, concepts, structures, functionalities and/or examples described herein are non-limiting, and the present invention may be used various ways that provide benefits and advantages in computing and mobile advertising in general.

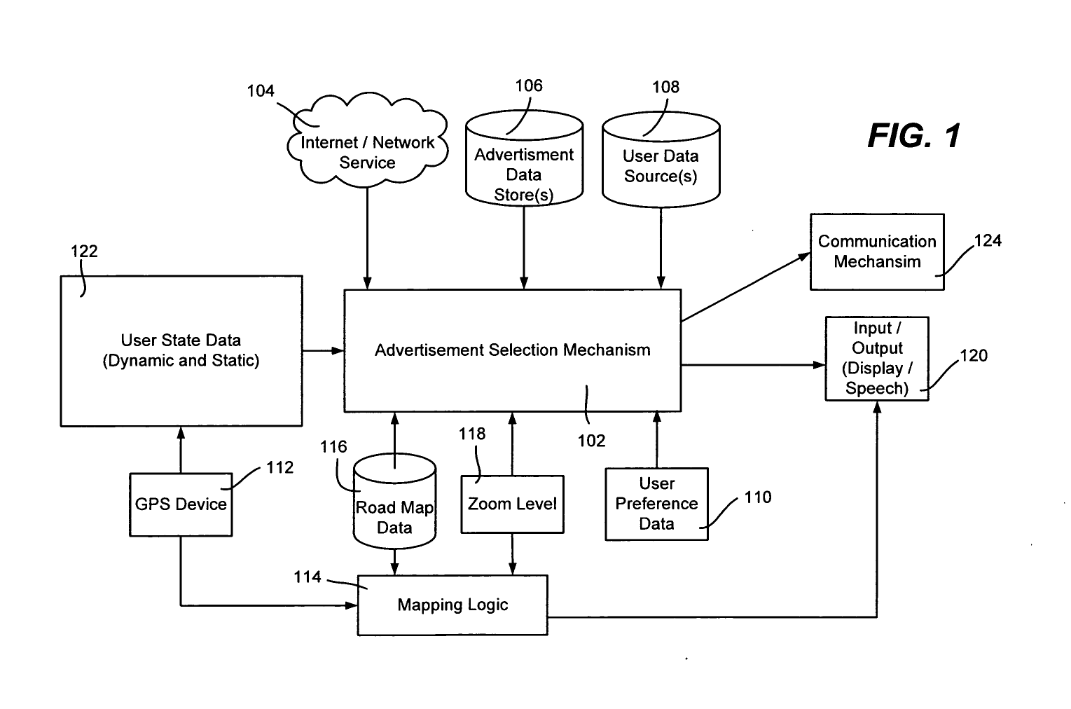

Turning to FIG. 1, there is shown a general block diagram of an architecture that combines various data with respect to determining advertisement delivery decision making. In general, an advertisement selection mechanism 102 receives input from a number of possible data sources, including the internet or network service 104, one or more advertisement data stores 106, and one or more user-provided data sources 108. Examples of user-provided data sources 108 include contacts, a task list, a calendar, and so forth. Other inputs to the advertisement selection mechanism 102 include user preference data 110; the user may input preference data, such as specific likes and dislikes, and historical data may be automatically saved for a user, e.g., the user's usual weekday morning route and stopping points. Any of the data may be accessed on demand, locally cached, or some combination thereof.

As also represented in FIG. 1, a global positioning system (GPS) device 112 feeds location and other information to mapping logic 114. As is known, the mapping logic 114 accesses road map data 116 to output a map representation based on a current zoom level 118 to an input/output mechanism 120, typically a touch-sensitive display screen of a navigation device. It is also common to have speech-provided directions (“turn left in one block”) as part of a navigation device.

The output of the GPS device 112 provides a significant amount of state data 122, particularly dynamic state data, whether directly or indirectly computed from the GPS output. Examples of such dynamic state data include current location, direction and speed, as well as current activity (driving, waiting, stop-and-go and so forth). Other dynamic state data includes current time, a start location, and/or an end destination if provided by the user. Still further dynamic state data (e.g., as sensed by airbag detection systems) may include the number of occupants in the automobile, and/or their individual weights, at least with respect to whether an occupant is likely an adult or child.

Other state data 122 is primarily static in nature, such as the make/model/status of the automobile, and the age and gender of the driver; (seat position, weight, time-of-day and so forth may be used to differentiate among multiple drivers). As described below, such contextual information may be used to deliver relevant advertisements, e.g., a minivan sensed full of children on a Saturday afternoon would likely be targeted to receive a very different type of advertisement than would a luxury car with one occupant on a Tuesday morning.

As can be readily understood, such state information 122, which may be combined with user-provided data from sources 108 (a calendar, task list and so forth) and/or user preference data 110 (e.g., cuisine preferences and dislikes), provides a mechanism for base advertisement presentment that is significantly more targeted than in an Internet scenario or a billboard scenario. As represented in FIG. 1, such information, along with the road map data 116 and zoom level 118, provide the advertisement selection mechanism 102 with a significant amount of decision making ability to output an very targeted advertisement to the output mechanism 120, (e.g., by blending or superimposing visible information over the map and/or outputting audio).

Moreover, in addition to selection of advertisements, how an advertisement is presented to a user via an in-vehicle navigation system is often an important aspect as to whether the advertisement will be recognized. For example, because while driving the driver's main task should not be to focus attention on the navigation screen, in general it is important to display an advertisement in a quickly readable manner that does not interfere with or distract from driving.

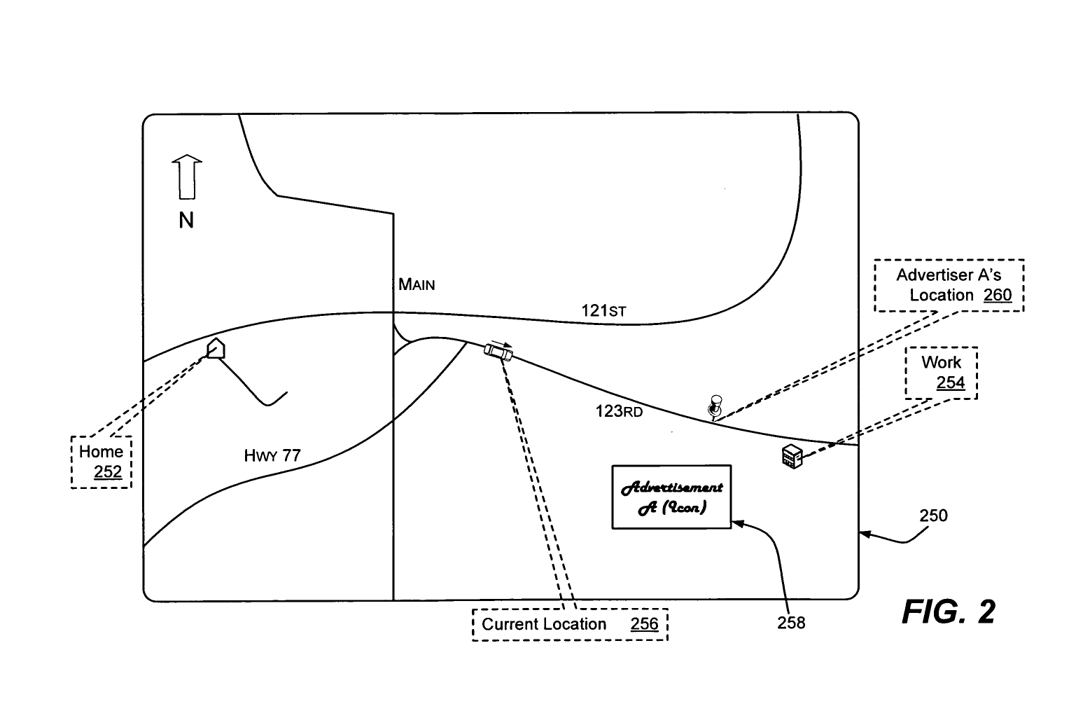

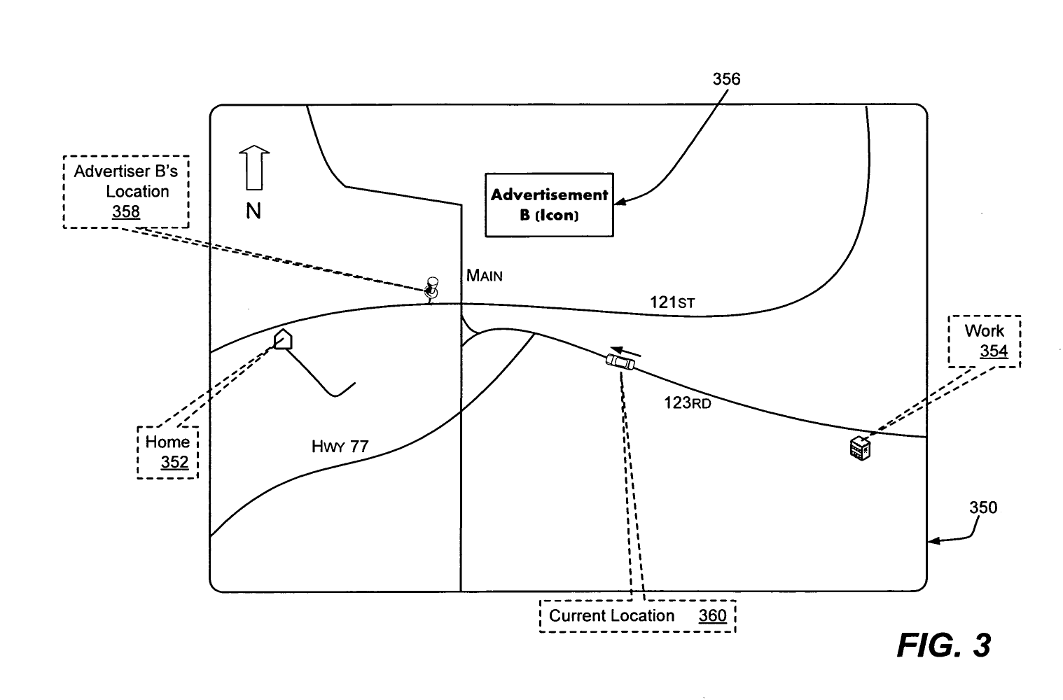

FIGS. 2 and 3 show a simplified example of the delivery of different advertisements, which may be based on any combination of state data 122, user preference data 110, and user-provided data from the sources 108. Note that FIGS. 2 and 3 use a display option in which the map is always oriented with North to the top, however an option in which the vehicle's current direction is always upward is very commonly used.

In FIG. 2, a map 250 is displayed in an example scenario in which a user is traveling from home 252 to work 254, and is currently at a location 256. At some time, the various inputs to the advertisement selection mechanism 102 combine such that the advertisement selection mechanism 102 selects an advertisement 258 for output. As mentioned above, virtually any presentation model may be used, however in this simplified example, the advertisement is delivered via a logo 258 for advertiser A that appears proximate the advertiser's location 260, which is denoted by a pushpin marker.

In contrast, FIG. 3 shows the same basic map 360, with at least two state changes, namely the user is traveling in the opposite direction and is at a slightly different location 360. In this example, the various inputs to the advertisement selection mechanism 102 combine such that the advertisement selection mechanism 102 selects a different advertisement 358 for output, corresponding to a different logo 358, for advertiser B, which appears proximate Advertiser B's location 360.

The following scenario further provides a more sophisticated example of how the various inputs combine to output a targeted advertisement. Consider a user X that gets into her car while at work, and enters “Home” in the navigation system. The navigation system creates an evening rush-hour route home for her. Moreover, as she drives along the route, she is presented with icons for a coffee shop, a fast food restaurant, and a pizza restaurant displayed at corresponding geographically accurate locations on the map.

User X presses the coffee shop icon and a dialog box appears asking whether she would like to send them her usual order. If she accepts, the navigation system adds the coffee shop as a stop along her route. The order may be automatically sent via a communications mechanism 124, or for example, the coffee shop's phone number is dialed on her mobile telephone where she is able to order. She then pulls into the coffee shop and picks up her drink.

User X continues along her route home and the time is now 5:15 pm, and close to dinner time. Knowing that she and her family have a preference for Chinese food, the navigation system outputs a custom advertisement for a local Chinese food restaurant near her house, along her route. If she presses the custom icon, a dialog box appears asking if she would like to send them her favorite order, (or possibly offering the option to see a menu). If she accepts, the navigation system adds the restaurant as a stop along her route, where she can stop and pick up her dinner order.

The next day, User X decides to come home early and travels along the same route. However, this time, because it is now 2:00 pm and closer to the time she normally programs on her calendar for the gym, an icon is displayed for a local sporting goods chain that has a store along her route home. As can be seen, in the above scenario, information is presented to the user based on her preferences for certain businesses, her location, her chosen navigation route, and the time of day.

Various business models are feasible for generating revenue from this form of advertising. For example advertisements may be monetized whenever the driver clicks on an icon in the navigation system, further monetized if the vehicle subsequently arrives at the destination for which an icon was clicked (e.g., arriving at the coffee shop), and still further monetization based on transmissions of favorite orders (e.g., sending the coffee shop pre-order for a drink). This is summarized in the table below:

| Ad Type | Description | Monetization |
|---|---|---|
| “Click-through” | Pressing a displayed | Provider paid a |
| | icon | nominal fee for |
| | | the click-through |
| “Conversion” | Arriving at a | Provider paid |
| | destination for which | whenever a |
| | an advertisement is | customer is |
| | displayed on the | directed to an |
| | navigation system | advertiser |
| “Percentage” | Transmitting a | Provider paid a |
| | favorite order or | percentage of the |
| | other transaction- | order that is |
| | based information in | transmitted |
| | advance of arriving | |

Further, there are specific tools available to potential advertisers to analyze the purchase of specific locations at specific times of day. For example, such tools may provide a typical map-like view of a region, overlaid with information for high-traffic areas based on time of day (e.g., a major freeway during rush hour) and propensity for users to click-through, convert, and purchase based on existing advertisers. Potential advertisers can click on locations and investigate how various parameters (time of day, demographics of potential customers, volume of ads, and so on) can affect the cost of an advertisement. Locations can be defined as regions (e.g., the area including and immediately surrounding the National Mall in Washington, D.C.), street segments (e.g., mile marker-to-mile marker on a freeway, or intersection-to-intersection on a surface street), or precise locations (e.g., a movie theatre parking lot). Once a potential advertiser determines the location and parameters for their advertisement, the advertiser can specify the icon to be displayed on the navigation map, the format of the message presented following a “click-through”, and specific offers they may want to float to customers based on a variety of parameters (day of the week, demographic information, and so on). The tools help the potential advertiser craft messages and icons that reduce interference with the driver's ability to maintain concentration on the road. Such tools created to help the potential advertiser create advertisements overlaid with real-time data from databases and tools that enable the potential advertiser to gauge the cost of placing an ad at the specific location at specific times to specific types of users. The tools used to enable potential advertisers to craft advertisements and present them to users may be broadly applicable to other forms of location-based advertising, beyond the automobile, such as including mobile phones, handheld devices, and mobile Web surfers.

As can be seen, the above technology may be implemented within the context of an in-vehicle entertainment and information system. As such, there is an available input/output mechanism (e.g., a touch screen display) 120, GPS device 112, and the various contextual information described above, including state data 122, user-provided data 108 and preference data 110. The technology also may be combined with Internet access. The integration among these systems combines data from the various sources to discern an accurate prediction of a driver's propensity for “clicking through” on a presented advertisement. By taking into account vehicle-specific factors and combining them with knowledge of a user's typical, current, and future activities, the advertisements that are presented to the user are likely significantly more relevant and therefore will have a higher degree of click-through and conversion.

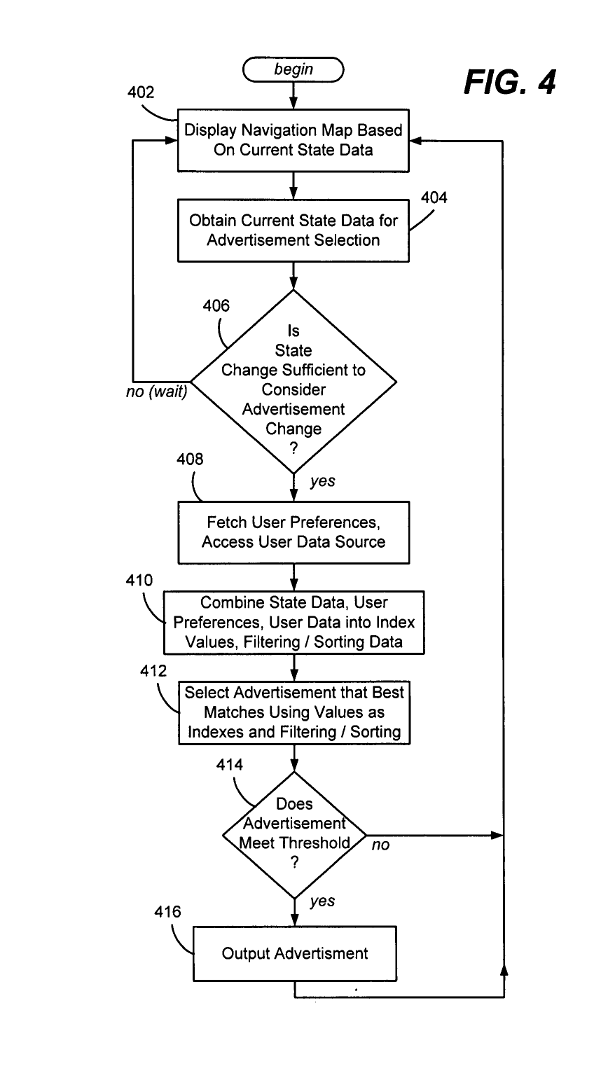

FIG. 4 is a simplified flow diagram summarizing example steps that may be taken to perform advertisement selection and delivery, beginning at step 402 where a user starts the navigation system, directly or indirectly by starting the automobile. Step 404 represents the advertisement selection mechanism 102 obtaining the current state data.

Step 406 represents evaluating the current state data to determine based on the state whether an advertisement should be changed (which includes outputting an advertisement for the first time this driving session). For example, when the user first starts the navigation system, this may be a sufficient state change. However, if thereafter the only state change is a few seconds of time and the user has not yet moved, any advertisement change should not be considered. Later, if enough time has passed, the user has entered a destination, and/or the user has changed locations, the corresponding state change may warrant performing the computations and accessing the data sources to determine whether an advertisement change is appropriate, whereby step 406 branches to step 408.

Step 408 represents fetching the user preference data and/or accessing the user data source, such as to read a calendar or task list. Step 410 represents combining the state data, user preference data and user data source into index values and/or filtering data. For example, the current location, direction and time of day may be used as an index to find coffee shops in the morning and restaurants at night; the current location, direction and amount of fuel may be used as an index to find gasoline stations. The preference data may be used as a filter or sorting mechanism to remove advertisements corresponding to businesses that the user dislikes, and to rearrange those that remain to select the most preferred candidate. Advertiser payment may be another sorting mechanism. Advertisements also may be sorted based on a scoring system, such as likely to click, unsure, and unlikely to click, or even given a numerical (e.g., percentage likely) value.

As a further example, the user's calendar or task data may be used to set a threshold to compare using the scoring system. For example, if a user's calendar data indicates the user is just barely on time (or will be late) for a meeting, then a high threshold will be set for advertisements that are generally optional and/or time consuming in nature, such as a sit-down lunch restaurant. Conversely, even if the user is late for a meeting at work, an advertisement for fuel may appear if the user may run out of gasoline before he will get to work, because a corresponding fuel advertisement at such a time would have a very high delivery value.

Step 412 represents selecting an advertisement, such as after using an index or indexes to select candidates, preference filtering, sorting and/or scoring. Step 414 represents evaluating the selected advertisement, e.g., the one with the highest score, against a threshold for whether that advertisement should be delivered at all given the user's delivery threshold. If so, step 416 is performed to output the advertisement, otherwise the process branches back to attempt again at a later time when a state change is deemed sufficient to reattempt.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable medium having computer-executable instructions, which when executed perform steps, comprising:
obtaining contextual data including current state data from a location-sensing device of a mobile system;
selecting an advertisement for output based on the contextual data; and
outputting the advertisement to an output mechanism of the mobile system.

2. The computer-readable medium of claim 1 wherein obtaining the contextual data comprises accessing user preference data, and wherein obtaining the current state data from the location-sensing device comprises receiving output from a GPS device.

3. The computer-readable medium of claim 1 wherein selecting the advertisement for output based on the contextual data includes accessing a data store of advertisements from paying advertisers.

4. The computer-readable medium of claim 1 wherein outputting the advertisement comprises outputting an icon or other image to an automobile navigation system display screen.

5. The computer-readable medium of claim 1 wherein outputting the advertisement comprises outputting audio.

6. The computer-readable medium of claim 1 wherein selecting the advertisement comprises combining current dynamic state data with at least one static data item.

7. The computer-readable medium of claim 1 wherein obtaining the contextual data comprises accessing user-provided data comprising calendar data, task data or contacts data, or any combination of calendar data, task data or contacts data.

8. In a mobile computing environment, a method comprising:
outputting an advertisement based upon contextual data including current state data;
receiving changed current state data corresponding to a change in the current state data relative to a previous state; and
determining whether to output a different advertisement based upon the contextual data including the changed current state data, and if so, selecting the different advertisement based upon the contextual data including the changed current state data, and outputting the different advertisement.

9. The method of claim 8 outputting the different advertisement comprises displaying an image at a location on a map or proximate the location on the map corresponding to a physical location of an advertiser.

10. The method of claim 8 wherein receiving the changed current state data comprises receiving data indicative of a location change, a speed change, a time change, a direction change, a destination, a fuel level change, or a route change, or any combination of a location change, a speed change, a time change, a direction change, a destination, a fuel level change, or a route change.

11. The method of claim 8 wherein determining whether to output a different advertisement based upon the contextual data comprises evaluating user preference data or evaluating user-provided data, or evaluating both user preference data and user-provided data.

12. The method of claim 8 wherein the contextual data includes age data, gender data, number of vehicle occupants data, vehicle make data, vehicle model data, or vehicle style data, or any combination of age data, gender data, number of vehicle occupants data, vehicle make data, vehicle model data, or vehicle style data.

13. The method of claim 8 wherein the contextual data includes user preference data corresponding to user likes or dislikes, or both likes and dislikes, of one or more businesses or one or more categories of businesses, or both one or more businesses and one or more categories of businesses.

14. The method of claim 8 further comprising, receiving user interaction with respect to the different advertisement, and in response, providing additional information with respect to the different advertisement.

15. The method of claim 14 wherein providing the additional information with respect to the advertisement comprises offering a user a means to communicate an order for a product or service corresponding to the advertisement.

16. In a mobile computing environment having a mapping mechanism, a system comprising:
a data store set containing advertisements; and
an advertisement selection mechanism coupled to a source of contextual data including current state data, and coupled to access the data store to select a selected advertisement from the data store based on the contextual data, and to output the advertisement to the mapping mechanism.

17. The system of claim 16 wherein the mapping mechanism includes a GPS device and a display screen of an automobile navigation system.

18. The system of claim 16 wherein the current state data comprises location data, speed data, time data, direction data, destination data, fuel level data, or route data, or any combination of location data, speed data, time data, direction data, destination data, fuel level data, or route data.

19. The system of claim 16 wherein the contextual data includes age data, gender data, number of vehicle occupants data, vehicle make data, vehicle model data, or vehicle style data, or any combination of age data, gender data, number of vehicle occupants data, vehicle make data, vehicle model data, or vehicle style data.

20. The system of claim 16 further comprising communication means, and input means for interacting with the advertisement, wherein the input means is coupled to the communication means to communicate an order for a product or service corresponding to the advertisement.
